(19) United States
(12) Patent Application Publication
(10) Pub. No.: US 2015/0237141 A1
(43) Pub. Date: Aug. 20, 2015

(54) C2X communication device and corresponding method

(71) Applicant: Ulrich Stählin, Eschborn (DE)

(72) Inventor: Ulrich Stählin, Eschborn (DE)

(21) Appl. No.: 14/428,848

(22) PCT Filed: Sep. 11, 2013
(86) PCT No.: PCT/EP2013/068832

§ 371 Date: Mar. 17, 2015

(30) Foreign Application Priority Data
Sep. 18, 2012 (DE) 10 2012 216 642.4

(51) Int. Cl. H04L 29/08; H04W 4/22

(52) U.S. Cl. CPC H04L 67/12; H04W 4/22; H04W 84/12

(57) ABSTRACT

In a method for the wireless transmission of data relevant to a vehicle, in the context of C2X communication with a vehicle or an infrastructure unit, to facilitate the introduction of C2X communication, at least part of the data is additionally generated as speech messages by an additional speech message transmission unit.

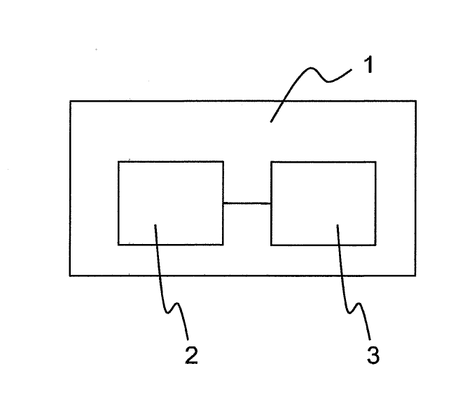

### CROSS-REFERENCE TO RELATED APPLICATIONS

This is a U.S. national stage of application No. PCT/EP2013/068832, filed on 11 Sep. 2013, which claims priority to the German Application No. DE 10 2012 216 642.4 filed Sep. 2012, the content of both incorporated herein by reference.

### BACKGROUND OF THE INVENTION

1. Field of the Invention The present invention relates to a communication apparatus that is configured for wireless transmission vehicle-relevant data to a vehicle or an infrastructure device for C2X communication, and to a corresponding method.

2. Related Art

For conventional communication between vehicles, the documents U.S. Pat. No. 6,958,707 B1, U.S. Pat. No. 4,241,326 and GB 2 408 371 A disclose systems in which vehicle drivers are informed about the approach of an emergency vehicle, for example a police emergency vehicle, an ambulance or a fire department. This information can be transmitted not only using the standard flashing or horn signal but also, for example, using radio frequencies.

Vehicle-to-surroundings communication (C2X or V2X communication) refers to wireless communication that can take place as vehicle-to-infrastructure communication (C2I) or vehicle-to-vehicle communication (C2C). This communication involves various information being transmitted as signals on different radio channels according to its content. For this Europe and the USA use wireless communication in the IEEE 802.11p specification based on a standard for communication by intelligent transport systems (ITS), in particular. However, there are also further standards in existence, some of which are likewise used. In Europe, communication based on IEEE 802.11p takes place in a frequency range from 5.875 to 5.905 GHz, for example, with a control channel (CCH) and at least two service channels (SCH) being implemented. The control channel is used for broadcast communication, where information needs to be transmitted to a plurality of or all subscribers in the communication network. This channel is reserved for short, safety-critical information with just low latencies and for communication management. The service channels are used for transmitting additional, non-safety-critical data, for example for application-specific information, road geometry, etc.

The structure of the transmitted information for C2X communication is stipulated in an industrial standard, particularly one from the ETSI, and is subject to the OSI layer model, in particular. The information received by a vehicle or an infrastructure device can be processed in a C2X communication apparatus and, by way of example, converted into a voice message and output, for example in a navigation appliance if the navigation appliance is warning about a hazard in the surroundings or on the planned route.

C2X communication also involves, inter alia, information being produced and forwarded by a large number of subscribers in a network, particularly a large number of vehicles. A large number of applications implemented by C2X communication use this network or involve the production and forwarding of as much information as possible relating to safety of movement, e.g., in respect of queues or other obstacles or in respect of the states of the vehicles.

A communication apparatus for a vehicle that can be used to perform such communication is already known from the document WO 2009/074655 A1. Examples of the use of C2X communication are the junction assistant, journey authorization applications, finding a parked vehicle, pedestrian detection, accident assistant, distance assistant or the like.

Hitherto, it has been assumed that vehicles can be equipped with such a communication apparatus only ex works. If such a communication apparatus is put in, particularly if it is designed on the basis of IEEE 802.11p, there could be problems with acceptance at the beginning of the introduction of such a communication system, since the rate of equipment of the vehicles will be low to begin with. In the period of introduction of a C2X communication system, it is highly likely that an owner of a vehicle with a complex C2X communication apparatus will have only minor advantages as a result of this apparatus, because the number of vehicles equipped with such a communication apparatus is still too low. This problem could be an obstacle to or at least delay the introduction of the inherently very useful system.

### SUMMARY OF THE INVENTION

An object of the present invention is therefore to provide a communication apparatus that can be used to reduce the startup problems highlighted above where a C2X system is introduced. A further object is to specify an inexpensive method that can be used to increase acceptance of the system.

The above object is achieved by a communication apparatus that has a transmission unit set up for producing and sending voice messages, hereinafter referred to as a voice message transmission unit.

In this case, voice messages are understood to mean analog or digital data packets from which an appropriately set-up communication device in a receiver can immediately, i.e., without further interim steps (apart from decoding and decompression), produce audible signals and output them via loudspeakers. Voice messages are therefore distinguished in that their data packet contains information from which audible signals can immediately be produced. In this case, a voice message consists of spoken text, in particular. In addition to spoken text, the voice messages can also contain signals, such as the sound of a signal horn on an emergency vehicle in the case of a message providing a warning about an emergency vehicle. In this case, depending on the communication medium used, the coding of the spoken text or of the additional signals is effected, in compliance with the respective standard used, either directly in analog form, for example in the case of FM transmission, or in digital form, possibly including special coding and compression, for example in the case of PMR transmission.

An advantage of the present invention is that such voice messages can be received and converted into audible signals by corresponding reception devices that do not need to be C2X communication apparatuses. Hence, drivers of vehicles without a C2X communication apparatus can use other mobile devices that provide them with at least some of the advantages of C2X communication. Although the users can only receive the voice messages without being provided with knowledge of details of the C2X communication, and the vehicle cannot automatically react to the messages and, by way of example, cannot automatically adjust the route guidance or activate a safety system, the driver is at least capable of using an important part of the C2X communication system in that he is able to receive and listen to voice messages if he has an appropriate reception device and a reproduction device with a loudspeaker. In light of the voice messages, a driver can then autonomously prepare himself for the corresponding situation and drive his vehicle accordingly. In particular, not all C2X signals can be represented by additional voice messages. Primarily messages that describe an event or a dynamic state are suitable for representation as a voice message. Examples of these are DENM (decentralized environmental notification message), SPaT (signal phase and timing) or CAM (cooperative awareness message). By contrast, “assisted messages”, which provide supplementary information boosting the quality of the use of the other messages, such as the TOPO message (topology), are not suitable. The technology may be very useful for getting into C2X communication, however, and can significantly increase acceptance of the system in the long term.

In contrast to the transmission of radio signals by emergency vehicles hitherto, the communication device according to the invention involves the message being sent not just via one channel, which is associated with “normal” C2X communication, but rather via at least two channels, namely the channel for “normal” C2X communication and the channel that is used to transmit the voice messages.

For the purposes of the present invention, C2X communication comprises communication by WLAN (IEEE 802.11a/b/g/n/p), by cellular radio (GSM, GPRS, EDGE, UMTS, LTE), by WiMax, by Bluetooth and the like, for example. In addition, the C2X system may include communication for a remote keyless entry system.

By way of example, the vehicle is a motor vehicle, such as an automobile, bus or truck, or else is a rail vehicle, a ship, an aircraft, such as a helicopter or airplane, or a bicycle.

In a development of the invention, the voice message transmission unit is set up for producing and sending the voice messages such that it is possible to use WLAN technology based on IEEE 802.11a/b/g/n, PMR technology, CB radio technology or FM radio band technology. For WLAN technology, the voice messages can preferably be sent as voice-over-IP voice messages. The advantage of using WLAN, particularly in the frequency range at 2.4 GHz or 5 GHz, is that the same chips as for regular C2X communication can be used in order to produce the voice messages. In the case of PMR (private mobile radio) technology, which is sent particularly in the frequency range at 446 MHz, it is possible to use the same chip as is also used, particularly at 434 MHz, to operate RKE (remote keyless entry). CB radio is of primary interest to truck drivers, since some of them already use a CB radio receiver in their vehicle.

Suitable voice messages are primarily what are known as DENM messages. These voice messages warn of events and hence directly of relevant hazards. Alternatively or additionally, a voice message can be generated for a CAM message, which by itself does not warn of a hazard, however. The definition of the DENM can be found in ETSI TS 102 637-3, for example, the definition of the CAM in ETSI TS 102 637-2, and for messages in the USA in SAE J2735. In this connection, it would be of great advantage if emergency vehicles were to announce an emergency journey likewise with a periodic voice message (e.g., with “emergency journey close by”). It would additionally be advantageous if, by way of example, a set of traffic lights were to transmit its traffic light phase status by voice message (e.g., as follows: “Traffic lights red, 5 seconds remaining”), with the traffic light phase status containing particularly the traffic light phase adopted by the traffic lights (red, amber, green) and possibly additionally the period remaining therefor.

In a preferred exemplary embodiment, the range of the voice message transmission unit is limited and is at least 150 m, preferably at least 500 m, particularly preferably at least 1 km. In urban areas, a range of approximately 150 m is sufficient, for example, whereas on freeways, for example, a range of 1 km is deemed useful. This achieves the same range as for “normal” C2X communication.

It is additionally an advantage if the voice message transmission unit is in a form such that it transmits the voice messages only in a particular, prescribed physical region, i.e., directionally. This is advantageous particularly in respect of traffic lights as a communication apparatus, in order to ensure that only the streets for which the messages are also relevant receive the voice messages.

In a further exemplary embodiment, a memory unit associated with the voice message transmission unit is used to store a multiplicity of predefined voice messages in order to avoid complex text-to-speech applications. The predefined voice messages can be selected and sent in accordance with the respective situation. As a result, although only a restricted number of voice messages are available, this should suffice particularly for the introductory phase of a C2X system, since only a limited number of applications are planned in this period, even for “normal” C2X communication.

The above object is additionally achieved by a method for wirelessly transmitting vehicle-relevant data to a vehicle or an infrastructure device for C2X communication. In particular, the method according to the invention involves an additional voice message transmission unit being used to transmit at least some of the data additionally as voice messages. The advantages and further refinement options that are specified above in connection with the apparatus exist with this method.

The advantage of transmitting the additional voice messages is particularly that during the introduction of C2X communication there are more people involved in the advantages of the technology and at least some of these advantages can be experienced. This increases acceptance of the C2X system and/or gives grounds for an incentive to buy the technology on the market.

### BRIEF DESCRIPTION OF THE DRAWING

Further advantages, features and opportunities for application of the present invention will also emerge from the description of exemplary embodiments below and the single figure. In this case, all features described and/or graphically represented form the subject matter of the present invention on their own or in any combination, including independently of their synopsis in the claims or the back-references therein.

In the drawing:

The FIGURE schematically shows a C2X communication apparatus according to an embodiment of the invention.

### DETAILED DESCRIPTION OF THE PRESENTLY PREFERRED EMBODIMENTS

The single figure schematically shows an inventive C2X communication apparatus 1 that is configured for C2X communication with other vehicles and infrastructure devices. In this case, the communication, for example based on the ETSI standard, is effected, by way of example, by WLAN based on IEEE 802.n, for example in a frequency range from 2.4 GHz to 2.4835 GHz or 5.15 GHz to 5.725 GHz.

The communication apparatus additionally has a voice message transmission unit 2. The voice message transmission unit 2 additionally generates voice messages, and sends them using the voice message transmission unit 2, from a large number of messages that the communication apparatus sends by “normal” C2X communication. By way of example, the voice messages can be sent as voice-over-IP voice messages by WLAN technology based on IEEE 802.11a/b/g/n. Alternatively, the voice message transmission unit 2 can be used to produce and send voice messages via a CB radio channel. For this, the voice message transmission unit 2 has an appropriate antenna, not shown. If analog transmission is not involved, each voice message produced in this manner contains in its data record a piece of information from which the receiver can tell that it is a voice message. In this case, this information is stipulated by the respective communications engineering standard used.

When a channel is free, the communication apparatus sends all C2X messages that can be represented as a voice message, also as a voice message. If the channel used for the voice messages is not adequate for this purpose, the messages are prioritized on the basis of their criticality, e.g., defined by the traffic class, and the prioritization list is used to decide which messages are sent. In this context, the messages having the highest priority are sent first, followed, if the channel still has capacity, by the messages with lower priorities. The concept of traffic classes is defined in the standardization document ETSI TS 102 637-4.

In a preferred exemplary embodiment, the inventive communication apparatus has a memory unit 3 that is connected to the voice message transmission unit 2 and stores a multiplicity of predefined voice messages (e.g. “the color of the traffic lights is green”, “green traffic light phase ending in 5 seconds” or “an ambulance on an emergency journey is approaching”, etc.), The voice message transmission unit 2 can resort to these stored voice messages for generating voice messages, and can thus avoid complex text-to-speech applications. In this context, the voice message transmission unit 2 selects from the multiplicity of stored voice messages the voice message or voice messages that fit(s) the respective situation and then sends the message(s).

If a driver of another vehicle or an infrastructure device now has a fitting reception device for the voice messages, for example a WLAN or CB receiver, it is possible for the transmitted voice messages to be received by the reception device and converted directly into audible signals, i.e., into a spoken text, for example, therein. This text is then presented via the loudspeakers of the receiver. The power of the V2X system can therefore be experienced directly. The invention therefore makes it a simple matter to make acceptance of a V2X system accessible to a large demographic group.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A communication apparatus (1) comprising:
a wireless transmitter configured to wirelessly transmit vehicle-relevant data to a vehicle or an infrastructure device for C2X communication; and
a voice message transmission unit (2) configured to produce and send voice messages.

12. The communication apparatus as claimed in claim 11, wherein the voice message transmission unit (2) is configured to use WLAN technology based on IEEE 802.11a/b/g/n, during the use of which the voice messages can be transmitted using voice-over-IP voice messages, PMR technology, CB radio technology or FM radio band technology.

13. The communication apparatus as claimed in claim 11, wherein the range of the voice message transmission unit (2) for voice messages is at least 150 m.

14. The communication apparatus as claimed in claim 11, wherein the voice message transmission unit (2) is configured to transmit the voice messages only in a particular, prescribed physical region.

15. The communication apparatus as claimed in claim 11, wherein the voice message transmission unit (2) has an associated memory unit (3) configured to store a multiplicity of predefined voice messages.

16. A method comprising:
wirelessly transmitting vehicle-relevant data to a vehicle or an infrastructure device for C2X communication; and
a voice message transmission unit (2) transmitting at least some of the vehicle-relevant data additionally as voice messages.

17. The method as claimed in claim 16, wherein the voice messages are transmitted by WLAN technology based on IEEE 802.11a/b/g/n using voice-over-IP messages, PMR technology, CB radio technology or FM radio band technology.

18. The method as claimed in claim 16, wherein the voice messages are sent with a range of at least 150 m.

19. The method as claimed in claim 16, wherein voice messages are transmitted by the voice message transmission unit (2) only in a particular, prescribed physical region.

20. The method as claimed in claim 16, wherein the voice message transmission unit (2) has an associated memory unit (3) storing a multiplicity of predefined voice messages, the method further comprising selecting from the memory unit (3) one voice message or a plurality of voice messages for transmission in accordance with a respective situation.

21. The communication apparatus as claimed in claim 11, wherein the range of the voice message transmission unit (2) for voice messages is at least 500 m.

22. The communication apparatus as claimed in claim 11, wherein the range of the voice message transmission unit (2) for voice messages is at least 1 km.

23. The method as claimed in claim 16, wherein the voice messages are sent with a range of at least 500 m.

24. The method as claimed in claim 16, wherein the voice messages are sent with a range of at least 1 km.
